(19) United States
(12) Patent Application Publication
(10) Pub. No.: US 2003/0064691 A1
(43) Pub. Date: Apr. 3, 2003

(54) Automatic radio frequency signal switching circuit

(75) Inventor: Chien Liang Chang, Taipei City (TW)

Correspondence Address: Bruce H. Troxell, DOUGHERTY & TROXELL, Suite 1404, 5205 Leesburg Pike, Falls Church, VA, 22041, US

(73) Assignee: JOIN Computer Co., Ltd.

(21) Appl. No.: 09/965,824

(22) Filed: Oct. 1, 2001

(51) Int. Cl. H04B 1/18; H04N 7/16; H04N 5/44; H04N 5/46

(52) U.S. Cl. 455/178.1; 348/729; 348/725; 455/150.1; 455/151.1; 455/151.4; 455/179.1; 455/188.1; 455/193.1

(57) ABSTRACT

An automatic radio frequency signal switching circuit is equipped with a plurality of AV input terminals and adopts an analog/digital adapter to transform all respective input analog signals into high level digital signals and a central processor is used to memorize the sequential orders of the respective AV signals which are sequentially output in a last-in-first-out manner to a television. At the same time, the central processor shuts off the ANT/CATV signal amplifier and the RF switch thereof so as to effect automatic switching operation. When no AV signals from AV equipment are being input, the central processor will instantly transmit another set of high electric level signals to the ANT/CATV signal amplifier and a power source of the RF switch thereof and the ANT/CATV signals are delivered to a television via the RF amplifier and the RF switch thereof whereby effect automatic RF switching operation. Such a circuit is made up of all electrical components, so there will be no poor mechanical contact possibly occurring, resulting in secure and stable operation in practical use.

### BACKGROUND OF THE INVENTION

The present invention relates to an automatic radio frequency signal switching circuit which is equipped with a plurality of AV input terminals and adopts an analog/digital adapter to transform all respective input analog signals into high level digital signals and a central processor is used to memorize the sequential orders of the respective AV signals which are sequentially output in a last-in-first-out manner to a television. At the same time, the central processor shuts off the ANT/CATV signal amplifier and the RF switch thereof so as to effect automatic switching operation. When no AV signals from AV equipment are being input, the central processor will instantly transmit another set of high level signals to the ANT/CATV signal amplifier and the RF switch thereof and the ANT/CATV signals are delivered to a television via the RF amplifier and the RF switch thereof whereby effect automatic RF switching operation. Such a circuit is made up of all electrical components, so there will be no poor mechanical contact possibly occurring, resulting in secure and stable operation in practical use.

Referring to FIG. 1A, a conventional radio frequency input device of a television 1 is equipped with a single input terminal 2. As a number of audio and video devices 3, such as a DVD player, video camera or game player, are to be coupled to the input terminal, in general a single radio frequency input terminal 2 of a common television 1 can not meet such a need, resulting in complaint of consumers. To cope with such an awkward situation, manual interference to replace the connection to the input terminal is unavoidable, causing inconvenience in practical use.

To solve such a problem of inadequate number of audio/video AV terminals in common use, as shown in FIGS. 1B, a prior art hand operated switching device 5 including a number of switches 4 to expand the AV input terminals each of which is associated with one of an audio video equipment to transmit AV signals to the television 6. Therefore, desired AV signals of any type of AV equipment 3 can be delivered to the television 6 by proper selection of one of the switches 4 in the switching device 5. The conventional mechanical type switches 4 of the switching device 5 are easily worn out of their terminals as a result of frequent use, resulting in poor contact in operation. In addition, a channel is easily interfered by a neighboring channel, it is not completely isolated without interference. So, this type of conventional hand actuated switches 4 of the switching device 5 is not satisfactory in operation at all. The inventor noticed such a problem and came up with a solution to tackle such a technical difficulty. cl SUMMARY OF THE INVENTION

Therefore, the primary object of the present invention is to provide a RF (Radio Frequency) signal switching circuit which is equipped with multiple AV (Audio Video) input terminals. As a user is operating general AV equipment (such as VCD player, video camera or game player and etc.), on the central processor of the circuit detecting video signals, it will send out control signals to automatically turn off the ANT/CATV signals so as to permit the AV signals from the AV equipment to be delivered to the a television. Besides, the CPU of the circuit can be used to memorize the sequential order of the input of video signals of the respective AV equipment and pick up and deliver the AV signals of the AV equipment of last switching on to the television. When all the AV pieces of equipment are shut off, the central processor of the circuit win transmit control signals to automatically turn on the ANT/CATV amplifier and the ANT/CATV RF switch, preventing a user from flipping a manual converter and causing poor electric contact and interference of neighboring channels. Thereby it can make the AV equipment and a TV set operate in a more stable manner.

### BRIEF DESCRIPTION OF THE DRAWINGS

FIG. 1A is a diagram showing flow chart of a prior art;

FIG. 1B is another diagram showing the flow chart of an amended prior art;

FIG. 2 is a block diagram of the flow chart of the signal switching of the present invention.

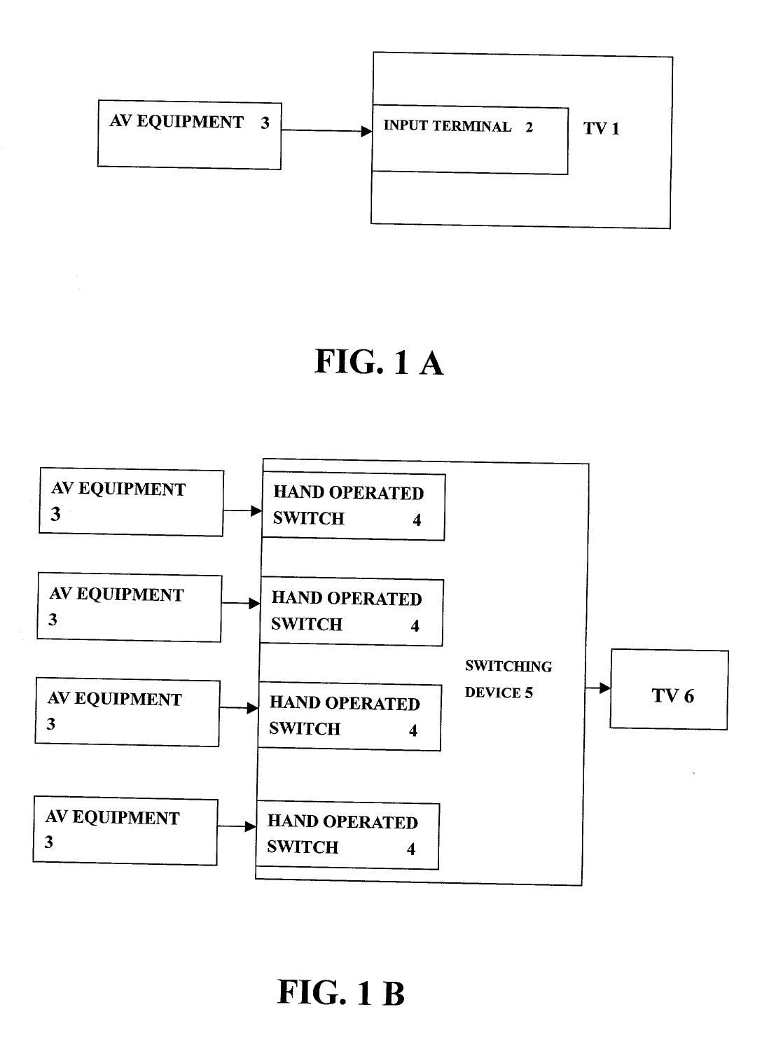

### DETAILED DESCRIPTION OF THE PREFERRED EMBODIMENTS

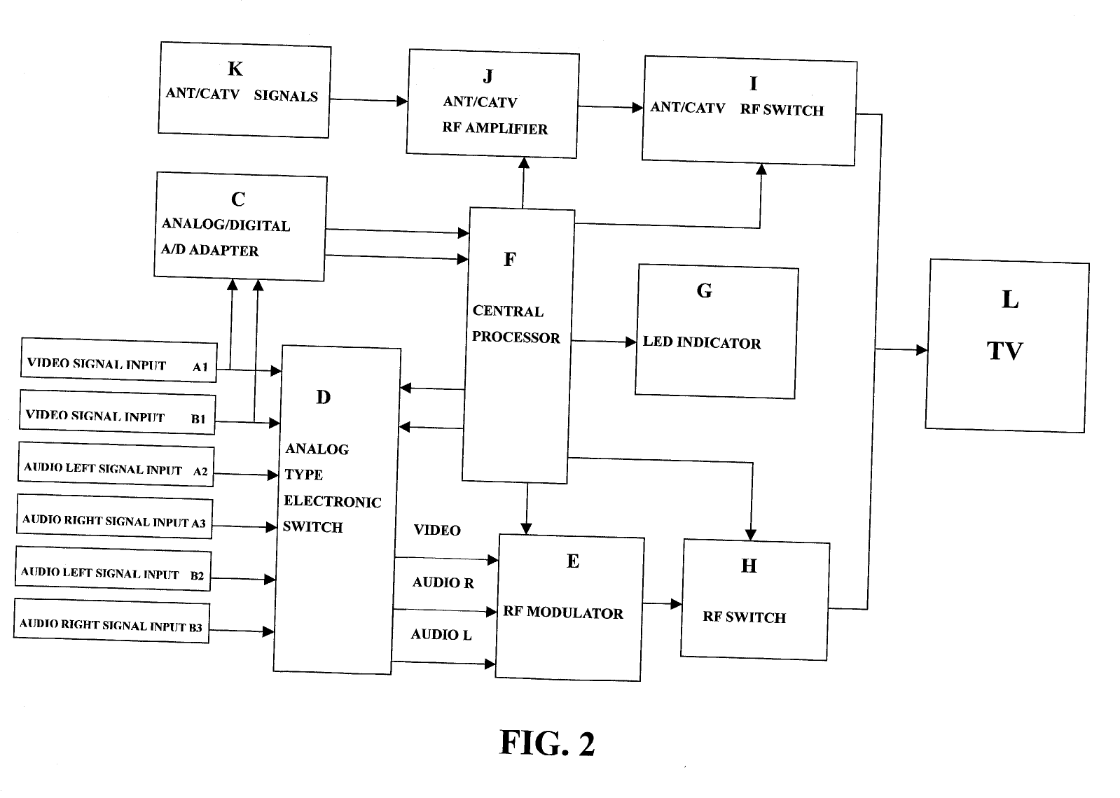

Referring to FIG. 2, the automatic RF (Radio Frequency) signal switching circuit of the present invention includes a set of multiple AV signal input terminals; in the present case, two sets of AV terminals are used, a first set of AV terminals includes a video signal input A1, a left audio signal input A2 and a right audio signal input A3; and a second set of AV terminals includes a video signal input B1, a left audio signal input B2 and a right audio signal input B3. The above two sets of AV input terminals are coupled to an analog type electronic switch D and the video signal input Al and the video signal input B1 are connected to an analog/digital adapter C at the same time. The analog/digital adapter C is an integrated circuit equipped with multiple converters each of which is coupled respectively to an output terminal of each set of analog video signal so as to permit analog video signals to be transformed into digital signals.

On the output terminal of one of the converters of the analog/digital adapter C generating a high-level voltage signal, it means video signals are input into the analog/digital adapter C, an AV device is actuated by a user. At then, the high level voltage signal is transmitted to the input terminal of a central processor F that can judge which pieces of AV equipment is actuated according to the connections of various terminals; and the information of the sequentially actuated AV equipment are stored into the memory unit of the central processor; and at the same time, the input pins of no input signals are detected and not attended and only the part with input signals is taken care.

The output of the central processor F is coupled to the analog type electronic switch D, radio frequency modulator E, RF switch H, ANT/CATV RF amplifier J, ANT/CATV RF switch I and LED indicator G. The analog/digital adapter C converts all the input AV signals transmitted from the respective sets into high level voltage outputs which are delivered to the central processor F. The central processor F memorizes the sequential orders of the inputs and sets a rule that the last-in-first-out, for instance, if it is desired that the first set of AV signals is actuated and then follows the second set, then it is preset that the later input second set of AV signals is first transmitted to a television L. At then, the central processor F provides a set of control voltage signals to turn on the analog type electronic switch D, the RF modulator E and the power of RF switch H, whereby the AV signals selected to output in priority are transmitted via the analog type electronic switch D to the RF modulator E and have been modulated, being delivered via the RF switch H to the television L. Simultaneously, the control voltage signals turn off the radio frequency amplifier J of ANT/CATV and the ANT/CATV RF switch I, resulting in the RF switch H under no interference condition completes the output to the television L with the LED indicator G showing that the current operation status of the AV equipment.

An automatic RF (Radio Frequency) signal switching circuit enables a user to cut off the ANT/CATV signals by means of the central processor F to avoid mutual interference when using general AV equipment, such as DVD, video cameras and game player and etc. Besides, it can respond to situations when different pieces of the AV equipment are activated by a user, the central processor F can memorize the sequential orders of the video signals transmitted from the respective piece of the AV equipment, and the AV signals from the last activated piece of AV equipment are then taken and delivered to the television L. When all pieces of the AV equipment are turned off, the ANT/CATV signal K switch is automatically turned on whereby a user does not have to operate manually a hand activated converter, avoiding poor contact of the component and interference with neighboring channels in use. Thus the system can be operated in a more stable manner.

I claim:

1. An automatic radio frequency signal switching circuit, comprising:
a set of multiple AV signal input terminals coupled to an analog type electronic switch; an analog/digital adapter of an integrated circuit equipped with multiple converters each of which is coupled respectively to an output terminal of each set of analog video signal so as to permit analog video signals to be transformed into digital signals;
an output of a central processor is coupled to said analog type electronic switch, a radio frequency modulator, an RF switch, ANT/CATV RF switch and LED indicator; wherein multiple set of AV input terminals having their video signals transformed into high voltage signals and transmitted to an input terminal of said central processor; said central processor provides a voltage signal to said analog type electronic switch, RF modulator and RF switch so as to select AV signals in priority to deliver via said analog type electronic switch and said RF modulator and further via said RF switch to a television; at the same time said central processor provides a voltage signal to shut off ANT/CATV RF switch so as to permit RF signals are transmitted to said TV without interference with an LED indicating AV equipment being in operation;
When no AV signals are input, said central processor instantly outputs another set of high level voltage signals to said ANT/CATV RF amplifying circuit and said RF switch so as to transmit ANT/CATV signals to a television, effecting automatic RF signal switching operation and an LED indicator shows that said ANT/CATV is in operation.

2. The automatic radio frequency signal switching circuit as claimed in claim 1 wherein said analog/digital adapter is an integrated circuit equipped with multiple converters, permitting input video signals to be transformed into digital ones; as an output terminal of one of said converters produces a high level electric voltage, indicating that AV signals are being delivered to said analog/digital adapter. a piece of said AV equipment is being activated by a user, at then said high level electric voltage signal is transmitted to an input terminal of said central processor that can judge which piece of AV equipment is activated from the corresponding input terminals thereof receiving said signal, and memorizes sequential orders of the activation of said AV equipment in a memory unit of said central processor and detects as well as leaves alone signal input terminals receiving no signals and only takes care of the part receiving input signals.
